(19) United States
(12) Patent Application Publication
(10) Pub. No.: US 2025/0245681 A1
(43) Pub. Date: Jul. 31, 2025

(54) MIX MODELING FOR MEDIA CONTENT

(71) Applicants: DISH Network L.L.C., Englewood, CO (US); DISH Network Technologies India Private Limited, Bangalore (IN)

(72) Inventors: Vinay Tiwari, Lone Tree, CO (US); Jeong Suh, Castle Pines, CO (US); Brandon Spector, Littleton, CO (US); Syed Misbah Ahmed, Karnataka (IN); Mohit Arvind Jichkar, Maharashtra (IN); Md Dilshad Akhtar, Bihar (IN)

(21) Appl. No.: 18/423,673

(22) Filed: Jan. 26, 2024

(51) Int. Cl. G06Q 30/0202; G06Q 30/0241; H04N 21/266

(52) U.S. Cl. CPC G06Q 30/0202; G06Q 30/0249; H04N 21/266

(57) ABSTRACT

The present disclosure is directed to methods and systems for identifying marketing channels with a machine learning model. The marketing system utilizes machine learning algorithms to generate a marketing mix model. The marketing mix model can provide a product provider with a tool to identify the impact of marketing (e.g., advertising) on online and offline channels. The marketing mix model can aggregate data from online and offline marketing channels. The data can include the amount of money spent on marketing via each channel, the time between an advertisement and a sale to a consumer, a date and time of the sale, number of sales, or any marketing information.

### BACKGROUND

A product provider can pay for advertisements to sell products on various platforms. For example, advertisements are played between segments of sporting events, or the advertisements are physically printed and mailed to consumers. However, based on the time of year and the state of the economy, a product provider can be unaware what advertisement location will result in the most purchases by consumers.

### BRIEF DESCRIPTION OF THE DRAWINGS

FIG. 1 illustrates an example of a distributed system for modeling marketing data, in accordance with one or more embodiments of the present technology.

FIG. 2 illustrates an example input processing system for implementing systems and methods for modeling marketing data, in accordance with one or more embodiments of the present technology.

FIG. 3 is a flow diagram illustrating a process used in some implementations for training an algorithm for a marketing mix model, in accordance with one or more embodiments of the present technology.

FIG. 4 is a flow diagram illustrating a process used in some implementations for analyzing data with a marketing mix model, in accordance with one or more embodiments of the present technology.

FIG. 5 is a flow diagram illustrating a process used in some implementations for transforming data by a marketing mix model, in accordance with one or more embodiments of the present technology.

FIG. 6 illustrates an example of the effect of an advertisement decay in accordance with one or more embodiments of the present technology.

FIG. 7 illustrates an example of components in a marketing system to determine marketing spend.

FIG. 8 illustrates an example of components for media planning models in a marketing system.

FIG. 9 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to systems and methods for identifying marketing channels with a machine learning model. Product providers can spend millions of dollars each year on marketing products to consumers. The marketing channels can include online channels (e.g., television commercials, advertisements on media content platforms, advertisements on web search engines, emails, advertisements on podcasts, etc.) and offline channels (e.g., advertisements mailed to consumers, advertisements in newspapers, billboards, etc.). However, currently product providers are unable to determine the type and number of online and offline channels to utilize to maximize sales to consumers.

The marketing system utilizes machine learning algorithms to generate a marketing mix model. The marketing mix model can provide a product provider with a tool to identify the impact of marketing (e.g., advertising) on online and offline channels. The marketing mix model can aggregate data from online and offline marketing channels. The data can include the amount of money spent on marketing via each channel, the time between an advertisement and a sale to a consumer, a date and time of the sale, number of sales, or any marketing information.

The marketing mix model can identify patterns in the data and a relationship between sales and marketing on each channel. In a first example, the marketing mix model identifies that when the product provider spends a first amount of money on marketing via a social media channel, product activation/sales increase by a first percentage amount. In a second example, the marketing mix model identifies that when the product provider spends a second amount of money on marketing via a television channel, product activation/sales increase by a second percentage amount.

The marketing mix model can analyze historical marketing data to generate recommendations for the financial amount and timing to market on different types of channels. For example, on a selected date, the marketing mix model recommends that A % of a marketing budget is spent on advertisement via channel A, B % of a marketing budget is spent on advertisement via channel B, C % of a marketing budget is spent on advertisement via channel C, D % of a marketing budget is spent on advertisement via channel D, etc.

Methods and systems disclosed herein can provide technical advantages over conventional systems. The disclosed mix model system provides: 1) customized recommendations for a product providers specific goals; 2) increases transparency and flexibility for running ad-hoc analysis; 3) reduces wasted marketing costs; 4) reduces bandwidth requirements by using selective marketing times; 5) provides channel level activation predictions; 6) provides channel level budget recommendations; 7) provides channel level daily spend guardrails; and 8) provides channel lift study prioritization.

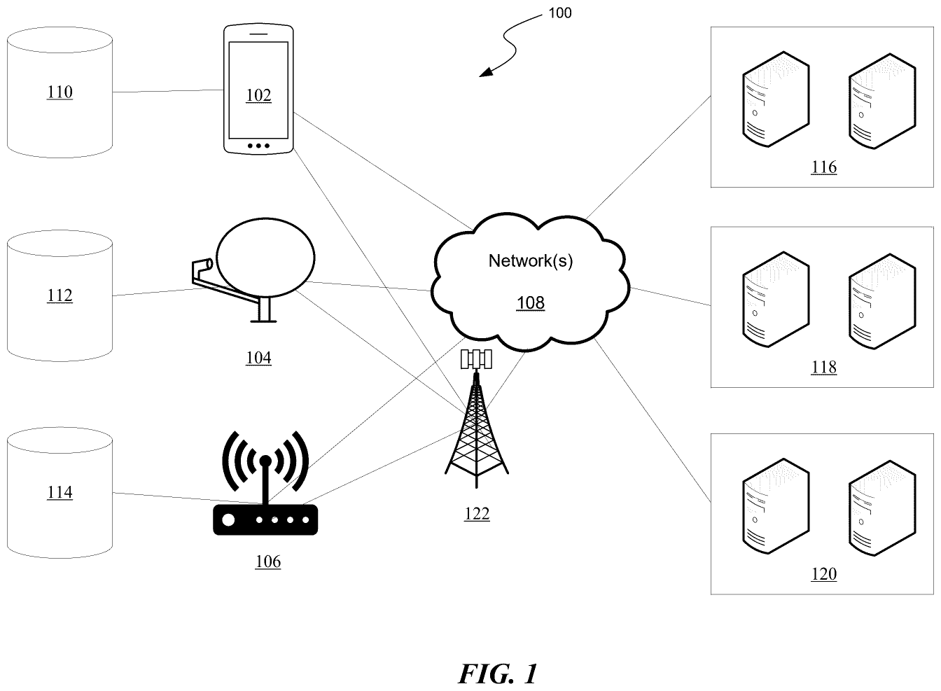

FIG. 1 illustrates an example of a distributed system for modeling marketing data. Example system 100 presented is a combination of interdependent components that interact to form an integrated whole for generating spend recommendations and modeling marketing data. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to support accessing a marketing system to input information (e.g., sales data, sentiment data, economic data, etc.) into a marketing mix model, and view/receive spend guidelines, recommendations, and illustrations of advertisement performance. In one example, a client device 102 may be a mobile phone, a client device 104 may be a smart OTA antenna, and a client device 106 may be a broadcast module box (e.g., set-top box). In other example aspects, client device 106 may be a gateway device (e.g., router) that is in communication with sources, such as ISPs, cable networks, internet providers, or satellite networks. Other possible client devices include but are not limited to tablets, personal computers, televisions, etc. In aspects, a client device, such as client devices 102, 104, and 106, may have access to a network from a gateway. In other aspects, client devices 102, 104, and 106, may be equipped to receive data (e.g., release assessment information) from a gateway. The signals that client devices 102, 104, and 106 may receive may be transmitted from satellite broadcast tower 122. Broadcast tower 122 may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

Client devices 102, 104, and 106 may be configured to run software that allows a user to access the marketing system, enter marketing information, and receive marketing recommendations. Client devices 102, 104, and 106 may access the marketing system and the marketing mix model through the networks. The feature data may be stored locally on the client device or run remotely via network(s) 108. For example, a client device may receive a signal from broadcast tower 122 containing marketing data. The signal may indicate the spend recommendation data. The client device may receive this spend recommendation data and subsequently store this data locally in databases 110, 112, and/or 114. In alternative scenarios, the user requested content data may be transmitted from a client device (e.g., client device 102, 104, and/or 106) via network(s) 108 to be stored remotely on server(s) 116, 118, and/or 120. A user may subsequently access the marketing data from a local database (110, 112, and/or 114) and/or external database (116, 118, and/or 120), depending on where the marketing data may be stored. The system may be configured to receive marketing data and perform a marketing analysis in the background.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the content data from a channel from an OTA antenna (e.g., antenna 104). A graphical user interface may display on the mobile device 102 the marketing data. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106.

In other examples, databases stored on remote servers 116, 118, and 120 may be utilized to assist the system in providing a user access to the marketing mix model system. Such databases may contain certain marketing data and/or spend recommendation data, such as spend guidelines, spend guardrails, advertisement release timing data, or graphs illustrating the marketing data. Such data may be transmitted via network(s) 108 to client devices 102, 104, and/or 106 to assist in modeling marketing data. Because broadcast tower 122 and network(s) 108 are configured to communicate with one another, the systems and methods described herein may be able to identify marketing data in different sources, such as streaming services, local and cloud storage, cable, satellite, or OTA.

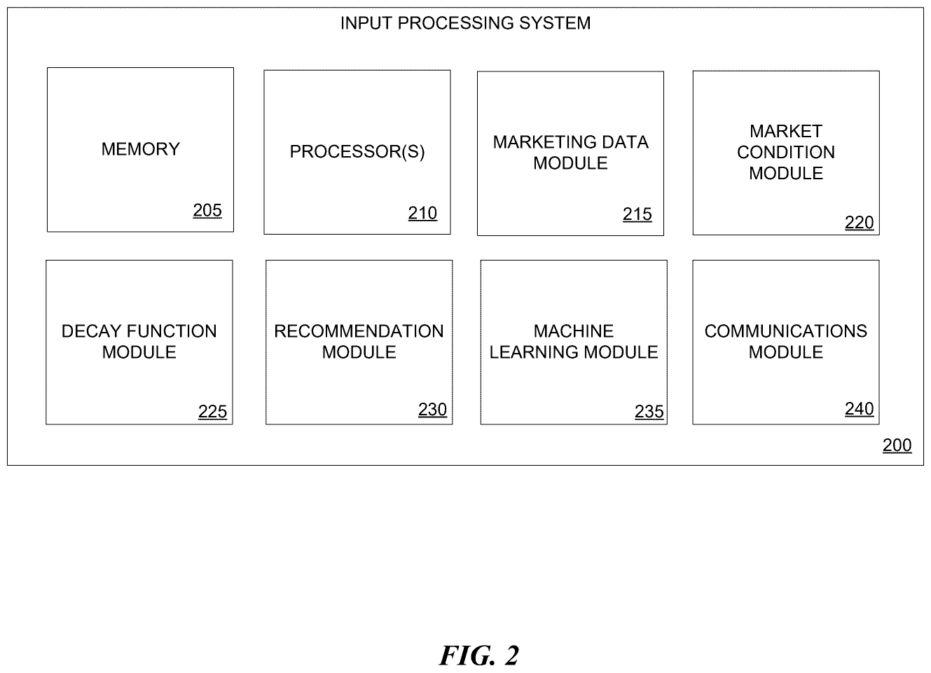

FIG. 2 illustrates an example input processing system for implementing systems and methods for modeling market data. The input processing system 200 (e.g., one or more data processors) is capable of executing algorithms, software routines, and/or instructions based on processing data provided by a variety of sources related to market modeling. The input processing system can be a general-purpose computer or a dedicated, special-purpose computer. According to the embodiments shown in FIG. 2, the disclosed system can include memory 205, one or more processors 210, marketing data module 215, market condition module 220, decay function module 225, recommendation module 230, machine learning module 235, and communications module 240. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 205 can store instructions for running one or more applications or modules on processor(s) 210. For example, memory 205 could be used in one or more embodiments to house all or some of the instructions needed to execute the functionality of the marketing data module 215, market condition module 220, decay function module 225, recommendation module 230, machine learning module 235, and communications module 240. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMS, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205. In some example aspects, memory 205 may store at least one database containing the advertisement information, historical spend information, marketing information, and any information associated with the marketing system.

Marketing data module 215 may be configured to receive data associated with online and offline channels from various sources, such as devices, databases, website scraping, or surveys. The data can include the amount of money spent on marketing via each channel, the time between an advertisement and a sale to a consumer, a date and time of the sale, number of sales, or any marketing information. The marketing data module 215 can apply weights to events associated with sales based on historical viewership. For example, media content purchases can increase on days leading up to and including a sporting event (e.g., Superbowl, Olympics, World Cup, etc.). The marketing data module 215 applies calculated event weightage as independent variables to model the effect due to upcoming events on product sales. For example, the day of a sporting event has a higher weightage than the day before, based on historical consumer purchases. Variables, such as location or time of year can be used to improve accuracy and timing of advertisements.

The marketing data module 215 analyzes sentiment data as independent variables to assess the impact of prevailing market sentiment on sale outcomes. The sentiment can be based on the amount of positive or negative language of the consumers. For example, a sentiment score below 50% indicates that there is more negative language about the company or product than positive language. The marketing data module 215 can collect the sentiment data from social media platforms, surveys, website scraping, or any type of feedback. Brand sentiment can impact consumer interest in the product. The marketing data module 215 can use the sentiment data to predict whether advertisement will result in product sales. Positive sentiment can indicate an opportunity to market to receptive consumers. Negative sentiment can indicate that consumer will not be receptive to advertisements and/or purchasing products. For example, during a network outage, the customer sentiment can be negative which indicates that it is not worth spending more money on advertising.

The marketing data module 215 can collect competitor data from competitors of the product provider. The competitor data includes competitor market share, competitor product price, and/or product offers. The marketing data module 215 can use the competitor data to identify times to market products and times to avoid marketing products to consumers. The marketing data module 215 can identify correlations between product activations and competitor pricing. For example. activations can decline when competitors are offering lower prices or discounts.

The marketing data module 215 can analyze macro-economic factors. The macro-economic factors can include market indicators, inflation rate, unemployment rate, consumer price index, the dollar to pound ratio, or any economic data. The macro-economic factors can indicate times to increase or decrease marketing of products. The macro-economic factors can indicate why consumers are not receptive to advertisements. For example, during an economic recession, spending more money on advertising may not help a company sell products as consumers have less money to spend on new products or subscriptions.

Market condition module 220 may be configured to determine the market condition based on the time of year, approaching events, sentiment of the products, competitor data, and/or macro-economic factors. The market condition module 220 can determine the when to recommend a product providers spends money on marketing based on the current and forecasted market conditions. For example, if there is a positive sentiment associated with a product or product provider, there is sporting event approaching, and the unemployment rate is below a threshold, the market condition module 220 determines the market condition is receptive to consumers buying products. The market condition module 220 can recommend a product provider spend money or not spend on advertisements based on the market condition.

Decay function module 225 may be configured model customize a function (e.g., adstock function) to illustrate spend data associated with each type of channel. The decay function module 225 can transform the spend data associated with each channel with a decay function to show the rate of decay per each day after an advertisement was shown on the channel. The decay function represents when a consumer is most likely to purchase a product after viewing the advertisement. For example, after a consumer views an advertisement on a streaming platform, the customer makes the purchase later (e.g., an hour later, next day, etc.) after researching the product or consulting with other consumers. Each type of channel has a customized decay function based on consuming data, as consumers remember and react differently to advertisements that are shown on television channels, streaming platforms, or physical mail.

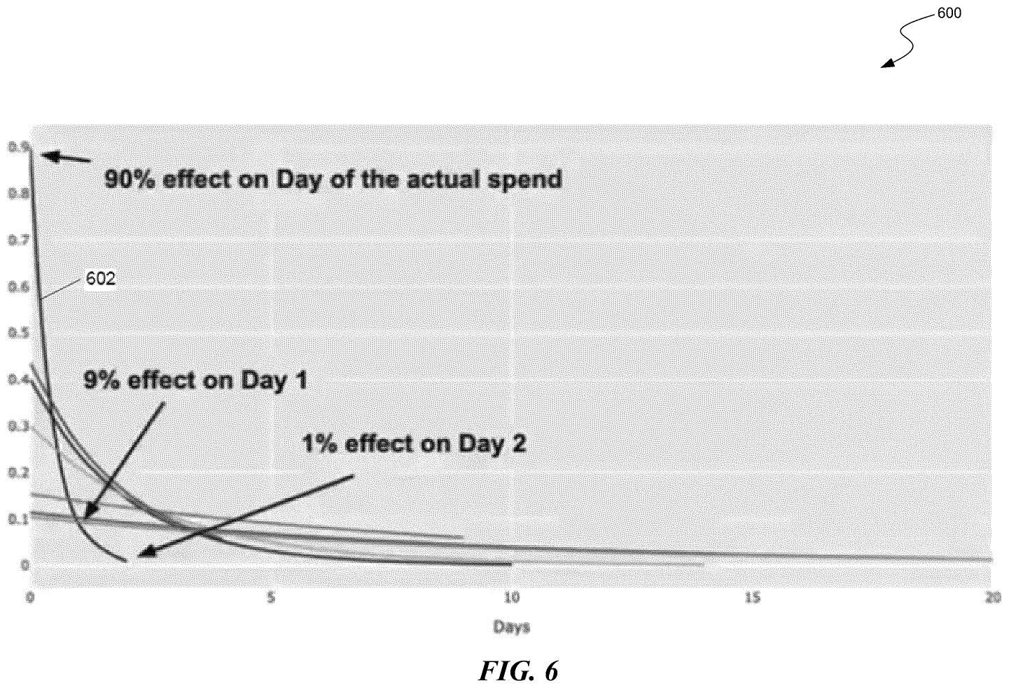

The decay function module 225 calculates the respective adstock values which capture the advertising effect associated with each channel. For example, money that is spent today on advertising is not realized for a time period. Image 600 of FIG. 6 illustrates how the effect of an advertisement decays over time (e.g., in days). An advertisement on channel 602 has a 90% effect on the day the advertisement is released, a 9% effect on day 1, a 1% effect on day 2, and continues to decay as time progresses. As illustrated in FIG. 6, the lines associated with different channels decay at different rates. The decay function module 225 can include an automated feature that selects adstock transformation techniques and computes individual adstock values for each channel.

Recommendation module 230 may be configured to generate spend guidelines for the budget of a product provider. The spend guidelines indicate the amount to spend on advertisements and when to release the advertisements. The spend guidelines are based on the available budget of a product provider, the type of channel, business objectives for a product provider, time of year, approaching events, day of the week, sentiment of the products, competitor data, and/or macro-economic factors. The spend guidelines can include channel level spend guardrails. The spend guardrails can include a minimum amount a product provider should spend to be profitable and a maximum amount a product provider should spend to avoid reaching a saturation point. The spend guidelines can include channel level budget recommendations based on the business objectives of the product providers. For example, the recommendation module 230 recommends a budget for a first online channel for the product provider to reach a ROMI goal. In some implementations, the recommendation module 230 generates channel level sale predictions based on the product providers following the spending guidelines.

The recommendation module 230 can analyze the effectiveness of advertising on each channel used by a product provider. The effectiveness can be based on the number of sales (e.g., subscription activations, product purchases, etc.) in relation to the amount of money the product provider spend on advertising via the channel. The recommendation module 230 can rank the channels based on profitability. In some implementations, the effectiveness is based on the time between releasing an advertisement and a sale of a product.

Machine learning module 235 may be configured to perform a marketing analysis for a product provider and generate spend guidelines (e.g., spend guardrails, budget recommendations, advertisement timing recommendations, channel selection recommendations, etc.) for a product provider. The machine learning module 235 may be configured to perform a marketing analysis and generate spend guidelines based on at least one machine-learning algorithm trained on at least one dataset reflecting user marketing analysis of previous marketing data and user generated spend recommendations. The at least one machine-learning algorithms (and models) may be stored locally at databases and/or externally at databases (e.g., cloud databases and/or cloud servers). Client devices (e.g., personal computers, smart phones, tablets, etc.) may be equipped to access these machine learning algorithms and intelligently perform a marketing analysis and generate spend guidelines based on at least one machine-learning model that is trained on historical marketing recommendations. For example, release history may be collected to train a machine-learning model to automatically perform a marketing analysis and generate spend guidelines for advertising to consumers.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process historical marketing analysis and other data stores (e.g., economic data, historical predictions, advertisement databases, etc.) to perform a marketing analysis and generate spend guidelines. Based on an aggregation of data from a marketing analysis database, external/internal portals, historical marketing databases, and other user data stores, at least one ML model may be trained and subsequently deployed to automatically perform a marketing analysis and generate spend guidelines. The trained ML model may be deployed to one or more devices. As a specific example, an instance of a trained ML model may be deployed to a server device and to a client device. The ML model deployed to a server device may be configured to be used by the client device when, for example, the client device is connected to the internet. Conversely, the ML model deployed to a client device may be configured to be used by the client device when, for example, the client device is not connected to the internet. In some instances, a client device may not be connected to the internet but still configured to receive satellite signals with marketing information. In such examples, the ML model may be locally cached by the client device.

Communications module 240 is associated with sending/receiving information (e.g., marketing data module 215, market condition module 220, decay function module 225, recommendation module 230, and machine learning module 235) with a remote server or with one or more client devices, databases, routers, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 240 sends marketing information received by the marketing data module 215, marketing condition data determined by market condition module 220, decay analysis data determined by the decay function module 225, and spend guidelines determined by recommendation module 230.

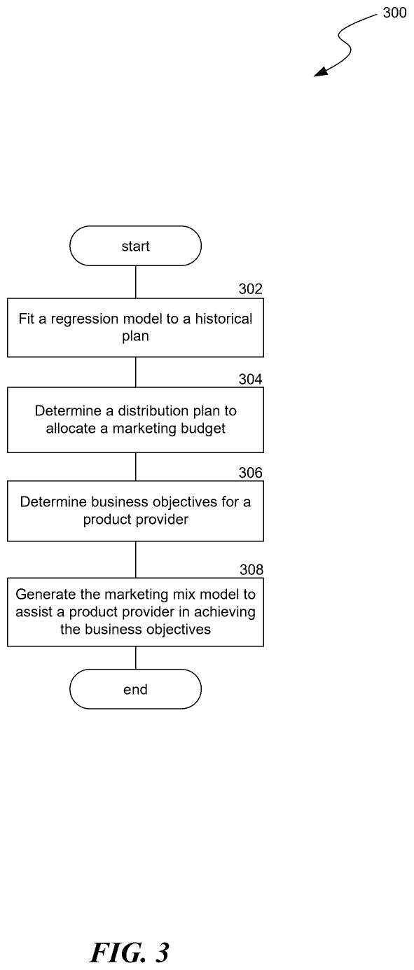

FIG. 3 is a flow diagram illustrating a process 300 used in some implementations for generating a marketing mix model, in accordance with one or more embodiments of the present technology. In some implementations, process 300 is triggered by a user activating a marketing mix model application, powering on a device, the user accessing the marketing mix model via a website portal, or the user downloading an application on a device to access the marketing mix model. In various implementations, some or all of process 300 is performed locally on the user device or performed by cloud-based device(s) that can provide/support the marketing mix model.

At block 302, the marketing system fits a regression model to an historical plan. The marketing system can adjust a regression algorithm to proportionally reflect the impact of an advertisement in relation to a marketing budget of a product provider. A standard regression algorithm may misrepresent the success of a channel by producing results before data of all the channels is collected. For example, if a first channel, allocated 0.5% of a company's marking budget, has success with consumer activations before other channels are utilized, the first channel can look inaccurately more successful compared to the unused channels. The marketing system adjusts the regression algorithm by adding a penalty factor specific to each channel to induce a prior effect (e.g., Bayesian effect). For example, if the total spend is below a threshold, then the activation percentage cannot be above a determined amount. For each channel, the marketing system determines what are the possible ranges of how much effect the channel can have on activations. Determining the range for each channel, can prevent the product provider from spending money on channels with limited consumer exposure.

At block 304, the marketing system determines a distribution plan to allocate a marketing budget at a daily level based on a seasonal effect, a holiday effect, and/or event weightage. The seasonal effect can be based on sport seasons (e.g., baseball season, hockey season, football season, etc.), yearly seasons (e.g., fall, summer, spring, or winter), wedding season, or any time of year that consumers buy products. For example, consumers are more likely to purchase a subscription to stream sports in weeks/days leading up to and during football, basketball, and hockey season, than after the season is complete. The holiday effect can be based on calendar holidays, cultural holidays, or any holiday during which consumers buy products. For example, between Thanksgiving Day and Christmas Day, consumers purchase subscriptions to stream Christmas movies. The event weightage can be based on a weight applied to an event based on historical viewership. For example, media content purchases can increase on days leading up to and including a sporting event (e.g., Superbowl, Olympics, World Cup, etc.). Historical viewership can indicate that most consumers activate an account the day before or the day of an event. The marketing system can apply a higher weight to the day before the event rather than two days before the event. For example, the Saturday before Superbowl Sunday has a higher weightage than the Friday before, based on consumer purchases. Variables, such as location or time of year can be used to improve accuracy and timing of advertisements.

At block 306, the marketing system determines business objectives for a product provider. The business objectives can include a return on marketing investment (ROMI) goal, a number of activations goal, sales revenue goal, how to optimize a marketing budget, or any business goal. In a first example, a product provider's objective can include determining the minimum budget needed to spend on advertising to result in a determined number of activations/sales. In a second example, a product provider's objective is determining the budget required to achieve a ROMI.

At block 308, the marketing system generates the marketing mix model (e.g., market condition data model) to assist a product provider in achieving the business objectives. The marketing mix model utilizes the adjusted regression algorithm and the distribution plan to provide the product provider with a tool to meet business objectives. The marketing mix model can use machine learning and artificial intelligence to calculate and determine the types of marketing channels, the amount of money to spend on advertising, and when to release the advertisements on the channels. The marketing mix model can provide a customizable actionable plan for the channel owners that identifies specific days to spend money on advertisements within lower and upper spend guard rails to maximize results on specific days (e.g., game day, holiday season, etc.).

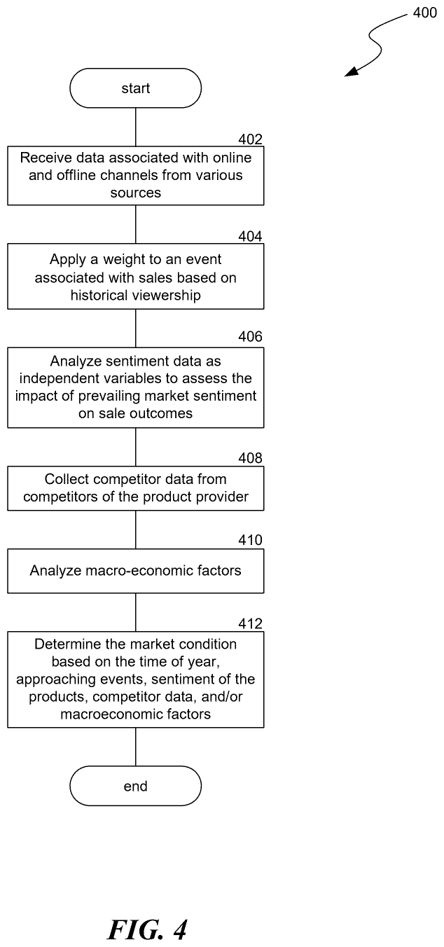

FIG. 4 is a flow diagram illustrating a process 400 used in some implementations for analyzing data by a marketing mix model, in accordance with one or more embodiments of the present technology. In some implementations, process 400 is triggered by a user activating a marketing mix model application, powering on a device, the user accessing the marketing mix model via a website portal, or the user downloading an application on a device to access the marketing mix model. In various implementations, some or all of process 400 is performed locally on the user device or performed by cloud-based device(s) that can provide/support the marketing mix model.

At block 402, the marketing mix model (e.g., market condition data model) receives data associated with online and offline channels from various sources, such as devices, databases, website scraping, or surveys. The data can include the amount of money spent on marketing via each channel, the time between an advertisement and a sale to a consumer, a date and time of the sale, number of sales, or any marketing information. The marketing mix model analyzes the data at various intervals, such as hourly, daily, weekly, etc. For example, the marketing mix model uses granular data at the daily level to analyze the inter-week effects of sales resulting from advertisements on the channels. In some cases, a channel receives more consumer traffic on a particular day of the week than on other days. For example, a television channel receives more views on a Sunday than on a Wednesday. The marketing mix model can organize the data according to channels, activations/sales, marketing spend, forecasted spend or sales, or any category.

At block 404, the marketing mix model applies a weight to an event associated with sales based on historical viewership. For example, media content purchases can increase on days leading up to and including a sporting event (e.g., Superbowl, Olympics, World Cup, etc.). The marketing mix model applies calculated event weightage as independent variables to model the effect due to upcoming events on product sales. For example, historical viewership can indicate that consumers activate an account the day of an event. The marketing mix model can apply a higher weight to the day of the event rather than the day before the event. For example, the day of a boxing match has a higher weightage than the day before, based on historical consumer purchases. Variables, such as location or time of year can be used to improve accuracy and timing of advertisements. For example, consumers in Texas care more about subscriptions to stream Nascar races than consumers in Maine.

At block 406, marketing mix model analyzes sentiment data as independent variables to assess the impact of prevailing market sentiment on sale outcomes. The sentiment can be based on the amount of positive or negative language of the consumers. For example, a sentiment score below 50% indicates that there is more negative language about the company or product than positive language. The marketing mix model can collect the sentiment data from social media platforms, surveys, website scraping, or any type of feedback. Brand sentiment can impact consumer interest in the product. The marketing mix model can use the sentiment data to predict whether advertisement will result in product sales. Positive sentiment can indicate an opportunity to market to receptive consumers. Negative sentiment can indicate that consumer will not be receptive to advertisements and/or purchasing products. For example, during a network outage, the customer sentiment can be negative which indicates that it is not worth spending more money on advertising.

At block 408, the marketing mix model collects competitor data from competitors of the product provider. The competitor data includes competitor market share, competitor product price, and/or product offers. The marketing mix model can use the competitor data to identify times to market products and times to avoid marketing products to consumers. In a first example, if a competitor is offering a sale or discount for a product, the marketing model recommends spending more money on advertisement to counteract the competitor or recommends avoiding spending money on advertising for a time period until the sale or discount of the competitor is complete. The marketing mix model can identify correlations between product activations and competitor pricing. For example. activations can decline when competitors are offering lower prices or discounts.

At block 410, the marketing mix model analyzes macro-economic factors of the economy environment. The macro-economic factors can include market indicators, inflation rate, unemployment rate, consumer price index, the dollar to pound ratio, or any economic data. The macro-economic factors can indicate times to increase or decrease marketing of products. In a first example, if the inflation rate is below a threshold, such as 4%, consumers are more likely to spend money on products than if the inflation rate is above the threshold. In a second example, if the unemployment rate is below a threshold, such as 2%, consumers are more likely to spend money on products than if the unemployment rate is above the threshold. The macro-economic factors can indicate why consumers are not receptive to advertisements. For example, during an economic recession, spending more money on advertising may not help a company sell products as consumers have less money to spend on new products or subscriptions.

At block 412, the marketing mix model determines the market condition based on the time of year, approaching events, sentiment of the products, competitor data, and/or macro-economic factors. The marketing mix model can determine the when to recommend a product providers spends money on marketing based on the current and forecasted market conditions. For example, if there is a positive sentiment associated with a product or product provider, there is sporting event approaching, and the unemployment rate is below a threshold, the marketing mix model determines the market condition is receptive to consumers buying products. The marketing mix model recommends a product provider spend money on advertisements based on the market condition. The market condition can indicate performance indicator values for a channel and how advertisements on a particular channel will perform. The marketing mix model can use the time of year, approaching events, sentiment of the products, competitor data, and/or macro-economic factors to identify performance indicator values to predict an aggregate channel performance value.

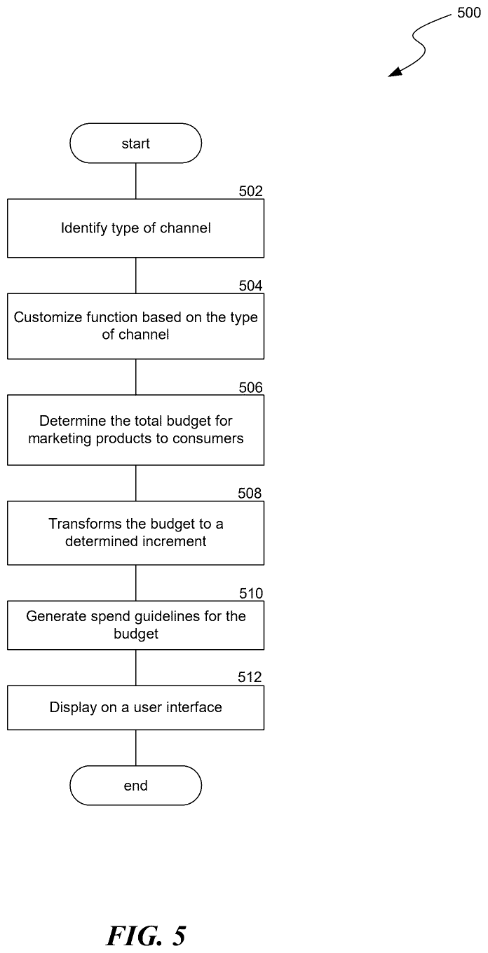

FIG. 5 is a flow diagram illustrating a process 500 used in some implementations for generating recommendations by a marketing mix model, in accordance with one or more embodiments of the present technology. In some implementations, process 500 is triggered by a user activating a marketing mix model application, powering on a device, the user accessing the marketing mix model via a website portal, or the user downloading an application on a device to access the marketing mix model. In various implementations, some or all of process 500 is performed locally on the user device or performed by cloud-based device(s) that can provide/support the marketing mix model.

At block 502, the marketing mix model identifies the types of marketing channels available to the product provider. The marketing channels can include online channels (e.g., television commercials, broadcast video data channels, advertisements on media content platforms, advertisements on web search engines, emails, advertisements on podcasts, etc.) and offline channels (e.g., advertisements mailed to consumers, advertisements in newspapers, billboards, etc.). Each online or offline channel can have different budget allocations for advertisements.

At block 504, the marketing mix model customizes a function (e.g., adstock function) to illustrate spend data associated with each type of channel. The marketing mix model can transform the spend data associated with each channel with a decay function to show the rate of decay per each day after an advertisement was shown on the channel. The decay function represents when a consumer is most likely to purchase a product after viewing the advertisement. For example, after a consumer views an advertisement on a streaming platform, the customer makes the purchase later (e.g., an hour later, next day, etc.) after researching the product or consulting with other consumers. Each type of channel has a customized decay function based on consuming data, as consumers remember and react differently to advertisements that are shown on television channels, streaming platforms, or physical mail.

The marketing mix model calculates the respective adstock values (e.g., performance indicator values) which capture the advertising effect associated with each channel. For example, money that is spent today on advertising is not realized for a time period. Image 600 of FIG. 6 illustrates how the effect of an advertisement decays over time (e.g., in days). An advertisement on channel 602 has a 90% effect on the day the advertisement is released, a 9% effect on day 1, a 1% effect on day 2, and continues to decay as time progresses. As illustrated in FIG. 6, the lines associated with different channels decay at different rates. The marketing mix model can include an automated feature that selects adstock transformation techniques and computes individual adstock values for each channel. In some implementations, the marketing mix model can impute business data prior to optimizing hyper-parameter tuning for adstocking.

An example approach to capturing carry over effects of spend is the use of adstock. Adstock implicitly distributes the amount of advertising exposure over several periods. Advertising that is effective at a given time is equal to residual adstock (e.g., what is “left over” from previous advertising), plus learning (e.g., adstock gained from current advertising). Equation 1 represents the advertising effort (e.g., GRP) in periods 1 to t and adstock is computed as follows:

$${Adstock}_{t} = \frac{1 - r}{f ( 1 - r ) + r} ( {fA}_{t} + {rA}_{t - 1} + {r}^{2} {A}_{t - 2} … + {r}^{t - 2} {A}_{2} + {r}^{t - 1} {A}_{1} ) \qquad Equation 1$$

A1 and A2 can represent advertising amounts. To find the correct adstock function for a channel, the marketing mix model can perform multiple back and forth iterations of choosing parameters, model training, model evaluation, and circle back to choosing parameters if a parameter is not a good fit. The terms in equation 1 are added in the increasing order of power (e.g., the exponentiation). The marketing mix model can generate an adstock value for parameters, such as time of year, approaching events, sentiment of the products, competitor data, and/or macro-economic factors.

For each channel type, the marketing mix model can identify performance indicator values to predict an aggregate channel performance value. For example, the performance value associated with the time of year, weight of the event, approaching events, sentiment of the products, competitor data, and/or macro-economic factors are used to predict an aggregate channel performance value. The aggregate channel performance value can be based on calculated adstock values and decay functions associated with each channel. In some implementations, the aggregate channel performance value is transmitted to a market condition data model (e.g., a machine learning model representing one or more market conditions).

At block 506, the marketing mix model determines the budget for marketing products to consumers via the online and offline channels. The total budget can be input by a user. In some implementations, the budget is determined based on historical marketing spend data, sales goals of the product provider, capital available for marketing, or any financial information. The budget can be organized according to any increment, such as minutes, hours, days, or months. The marketing mix model can determine the budget based on the market condition (determined at block 412 of FIG. 4).

At block 508, the marketing mix model transforms the budget according to a determined increment (e.g., daily level). For example, if the product provider gives advertising money to a streaming service on a weekly basis to play advertisements, the marketing mix model converts the weekly data into daily granularity. The increment of transforming the budget can be integrated in the marketing mix model as an independent variable. For example, a daily or hourly transformation increment more accurately reflects how advertisement are encountered by a consumer. A consumer can view more advertisements on a Sunday than a Tuesday. In some implementations, the marketing model receives, from the market condition data model, one or more optimal time value that corresponds to the market condition(s). The optimal time value can indicate a time to display a product on a channel.

At block 510, the marketing mix model generates spend guidelines for the budget. The spend guidelines indicate the amount to spend on advertisements and when to release the advertisements. The spend guidelines are based on the market condition, available budget of a product provider, the type of channel, business objectives for a product provider, time of year, approaching events, weights associated with the approaching events, day of the week, sentiment of the products, competitor data, and/or macro-economic factors. The spend guidelines can include channel level spend guardrails. The spend guardrails can include a minimum amount a product provider should spend to be profitable and a maximum amount a product provider should spend to avoid reaching a saturation point. The spend guidelines can include channel level budget recommendations based on the business objectives of the product providers. For example, the marketing mix model recommends a first budget for a first online channel and a second budget for a second online channel for the product provider to reach a ROMI goal. In some implementations, the marketing mix model generates channel level sale predictions based on the product providers following the spending guidelines.

The marketing mix model can analyze the effectiveness of advertising on each channel used by a product provider. The effectiveness can be based on the number of sales (e.g., subscription activations, product purchases, etc.) in relation to the amount of money the product provider spend on advertising via the channel. The marketing mix model can rank the channels based on profitability. In some implementations, the effectiveness is based on the time between releasing an advertisement and a sale of a product.

At block 510, the marketing mix model displays the spend guidelines and recommendations on a user interface. The user interface can display a dashboard with a recommended spend amount, a currently spent amount, and a forecasted spend amount. The dashboard can organize the data on a per channel and/per platform basis. Product providers can identify missed opportunities and region of maximum return. The user interface can display an interactive applet/module with what if calculations and live results tracking of the product providers marketing data.

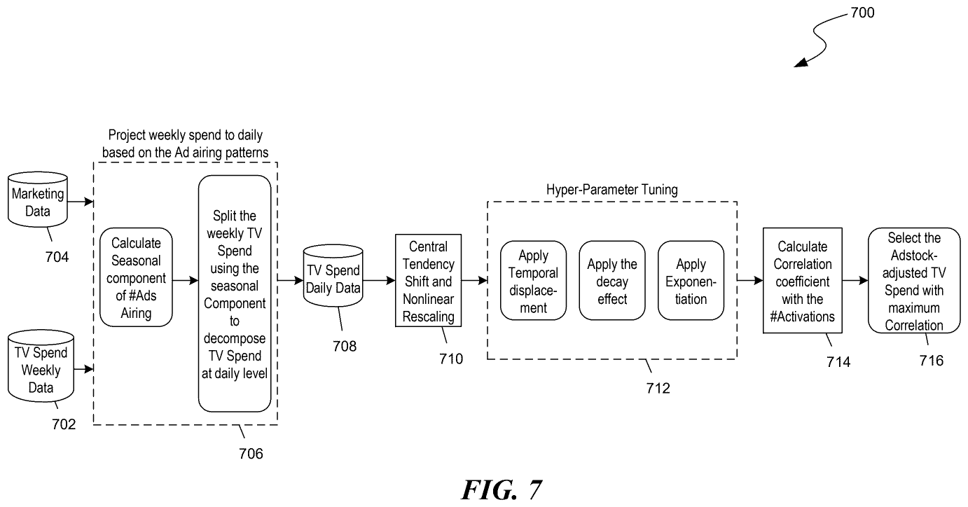

FIG. 7 illustrates an example of components in a marketing system 700 to determine marketing spend. The TV spend weekly data 702 and the marketing data 704 are input into a decomposition component 706. The decomposition component 706 projects weekly spend data to daily spend data based on the advertisement airing patterns, by: calculating seasonal components of the number of advertisements airing, and splitting the weekly TV spend using the seasonal component to decompose TV spend at a daily level. The decomposition component 706 outputs the TV spend daily data 708.

The shift and rescaling component 710 receives the TV spend daily data 708 and performs a central tendency shift and nonlinear rescaling. A central tendency shift can refer to a change in the typical or central value of a distribution of data. Measures of central tendency, such as the mean, median, and mode, represent the “center” or average of a set of values. A central tendency shift can indicate that this “center” has changed, indicating a systematic movement in the data. Central tendency shift and nonlinear rescaling can remove the bias of scale in various channel spends. Some channels may spend $10,000 per day, where other channels may spend $50,000 per day. To bring this data on the same scale, the shift and rescaling component 710 performs a central tendency shift based on the mean. The data points can carry the same pattern on a varied scale post this transformation.

The output of the shift and rescaling component 710 is input into the hyper-parameter tuning component 712. The hyper-parameter tuning 712 applies temporal displacement, the decay effect, and exponentiation to the output of the shift and rescaling component 710. An example approach to capturing carry over effects of spend is the use of adstock. Adstock implicitly distributes the amount of advertising exposure over several periods. Advertising that is effective at a given time is equal to residual adstock (e.g., what is “left over” from previous advertising), plus learning (e.g., adstock gained from current advertising). Equation 1 represents the advertising effort (e.g., GRP) in periods 1 to t and adstock is computed as follows:

$${Adstock}_{t} = \frac{1 - r}{f ( 1 - r ) + r} ( {fA}_{t} + {rA}_{t - 1} + {r}^{2} {A}_{t - 2} … + {r}^{t - 2} {A}_{2} + {r}^{t - 1} {A}_{1} ) \qquad Equation 1$$

A1 and A2 can represent advertising amounts. To find the correct adstock function for a channel, the marketing mix model can perform multiple back and forth iterations of choosing parameters, model training, model evaluation, and circle back to choosing parameters if a parameter is not a good fit. The terms in equation 1 are added in the increasing order of power (e.g., the exponentiation).

The correlation component 714 receives the output of the hyper-parameter tuning 712 and calculates the correlation coefficient with the number of activations. The adstock selection component 716 receives the correlation coefficient and selects the adstock-adjusted TV spend with the maximum correlation. The correlation coefficient is a statistical measure that quantifies the strength and direction of a linear relationship between two variables. The correlation coefficient assesses how well changes in one variable predict changes in another variable. To predict the product activations/sales, the correlation between activations and spend can be high. The marketing mix model can use a correlation coefficient as a precheck to qualify to the model building stage.

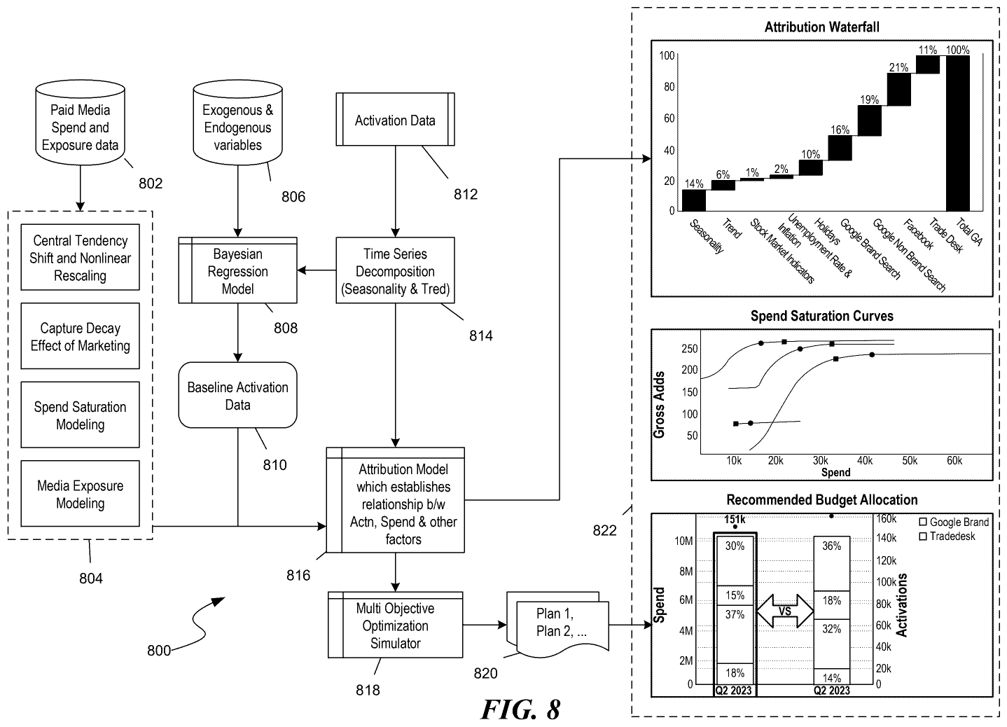

FIG. 8 illustrates an example of components in a marketing system 800 for media planning models. Paid media spend and exposure data 802 is input into the adjustment component 804. The adjustment component 804 performs central tendency shift and nonlinear rescaling, captures the decay effect of marketing, performs spend saturation modeling, and performs media exposure modeling. Spend saturation modeling can illustrate the non-linear relationship between spend and product activations/sales. To model for this effect, the adjustment component 804 can perform non-linear scaling of data using log or exponential transformation.

A Bayesian Regression model 808 receives exogenous and endogenous variables 806 and outputs baseline activation data 810. Examples of exogenous variables can include consumer price index, holidays, stock market index, unemployment rate, dollar to pound rate, etc. Examples of endogenous variables can include price change, channel addition/deletion, tune-in events, etc. Exogenous and endogenous variables can be included in the modeling phase to trap non-spend effects on the outcome variable (i.e., product activations/sales).

The decomposition component 814 receives activation data 812 and performs time series decomposition (e.g., seasonality and historical trend data). The output from the decomposition component can be input in the Bayesian Regression model 808.

The baseline activation data 810, the output from the adjustment component 804, and the output from the decomposition component 814 are input into the attribution model 816. The attribution model 816 determines the relationship between activations, spend, and any related marketing factors. An optimization simulator 818 performs multi-objective optimization simulations on the output of the attribution model 816 and develops plans 820, such as spend guidelines, marketing recommendations, etc. The output of the attribution model 816 and the plans 820 are displayed on a dashboard 822. The dashboard 822 displays attribution waterfall, spend saturation curves, and recommended budget allocations.

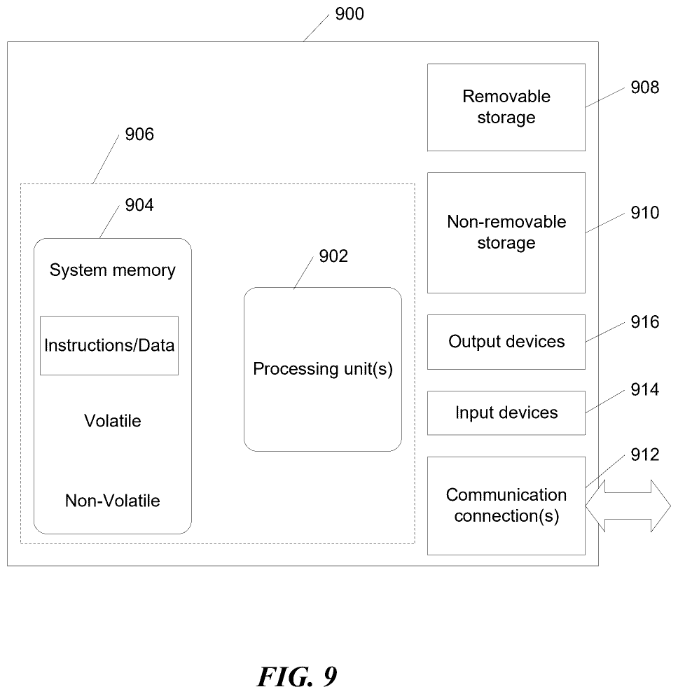

FIG. 9 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 900 typically includes at least one processing unit 902 and memory 904. Depending on the exact configuration and type of computing device, memory 904 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 9 by dashed line 906. Further, environment 900 may also include storage devices (removable 908 and/or non-removable 910) including, but not limited to, magnetic or optical disks or tape. Similarly, environment 900 may also have input device(s) 914 such as keyboard, mouse, pen, voice input, etc., and/or output device(s) 916 such as a display, speakers, printer, etc. Also included in the environment may be one or more communication connections, 912, such as Bluetooth, WiFi, WiMax, LAN, WAN, point to point, etc.

Operating environment 900 typically includes at least some form of computer readable media. Computer readable media can be any available media that can be accessed by processing unit 902 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 900 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively.

Several implementations of the disclosed technology are described above in reference to the figures. The computing devices on which the described technology may be implemented can include one or more central processing units, memory, user devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method comprising:
identifying a broadcast video data channel associated with a product provider, wherein the broadcast video data channel includes an identifiable channel type;
based on the identifiable channel type, identifying one or more performance indicator values to predict an aggregate channel performance value;
processing the one or more performance indicator values to generate the aggregate channel performance value;
transmitting the aggregate channel performance value to a market condition data model representing one or more market conditions; and
receiving, from the market condition data model, at least one optimal time value that corresponds to the one or more market conditions, wherein the at least one optimal time value indicates a time to display a product on the broadcast video data channel.

2. The method of claim 1, further comprising:
analyzing sentiment data associated with the product provider or associated with the product of the product provider;
analyzing one or more macro-economic factors associated with an economic environment to display the product on the broadcast video data channel; and
determining the one or more market conditions based on the sentiment data and the one or more macro-economic factors.

3. The method of claim 1, further comprising:
applying a weight to an event associated with displaying the product on the broadcast video data channel; and
determining the at least one optimal time value for the product provider to display the product on the broadcast video data channel based on the weight of the event.

4. The method of claim 1, further comprising:
generating the market condition data model to represent a result of marketing content on revenue for the product provider, wherein the market condition data model includes a machine learning algorithm, an adjusted regression algorithm, and a distribution plan to present the marketing content.

5. The method of claim 1, the method further comprising:
determining one or more objectives of the product provider; and
selecting two or more channels on which to display the product based on the one or more objectives.

6. The method of claim 1, the method further comprising:
generating spend guidelines for a marketing budget of the product provider, wherein the spend guidelines include a minimum spend amount the product provider should spend displaying the product on the broadcast video data channel and a maximum spend amount the product provider should spend displaying the product on the broadcast video data channel.

7. The method of claim 6, wherein the spend guidelines are generated by at least one machine-learning algorithm, wherein the at least one machine-learning algorithm is trained based on at least one dataset associated with previously generated spend guidelines.

8. A computing system comprising:
one or more processors; and
one or more memories storing instructions that, when executed by the one or more processors, cause the computing system to perform a process comprising:
identifying a broadcast video data channel associated with a product provider, wherein the broadcast video data channel includes an identifiable channel type;
based on the identifiable channel type, identifying one or more performance indicator values to predict an aggregate channel performance value;
processing the one or more performance indicator values to generate the aggregate channel performance value;
transmitting the aggregate channel performance value to a market condition data model representing one or more market conditions; and
receiving, from the market condition data model, at least one optimal time value that corresponds to the one or more market conditions, wherein the at least one optimal time value indicates a time to display a product on the broadcast video data channel.

9. The computing system of claim 8, wherein the process further comprises:
analyzing sentiment data associated with the product provider or associated with the product of the product provider;
analyzing one or more macro-economic factors associated with an economic environment to display the product on the broadcast video data channel; and
determining the one or more market conditions based on the sentiment data and the one or more macro-economic factors.

10. The computing system of claim 8, wherein the process further comprises:
applying a weight to an event associated with displaying the product on the broadcast video data channel; and
determining the at least one optimal time value for the product provider to display the product on the broadcast video data channel based on the weight of the event.

11. The computing system of claim 8, wherein the process further comprises:
generating the market condition data model to represent a result of marketing content on revenue for the product provider, wherein the market condition data model includes a machine learning algorithm, an adjusted regression algorithm, and a distribution plan to present the marketing content.

12. The computing system of claim 8, wherein the process further comprises:
determining one or more objectives of the product provider; and
selecting two or more channels on which to display the product based on the one or more objectives.

13. The computing system of claim 8, wherein the process further comprises:
generating spend guidelines for a marketing budget of the product provider, wherein the spend guidelines include a minimum spend amount the product provider should spend displaying the product on the broadcast video data channel and a maximum spend amount the product provider should spend displaying the product on the broadcast video data channel.

14. The computing system of claim 13, wherein the spend guidelines are generated by at least one machine-learning algorithm, wherein the at least one machine-learning algorithm is trained based on at least one dataset associated with previously generated spend guidelines.

15. A non-transitory computer-readable medium storing instructions that, when executed by a computing system, cause the computing system to perform operations comprising:
identifying a broadcast video data channel associated with a product provider, wherein the broadcast video data channel includes an identifiable channel type;
based on the identifiable channel type, identifying one or more performance indicator values to predict an aggregate channel performance value;
processing the one or more performance indicator values to generate the aggregate channel performance value;
transmitting the aggregate channel performance value to a market condition data model representing one or more market conditions; and
receiving, from the market condition data model, at least one optimal time value that corresponds to the one or more market conditions, wherein the at least one optimal time value indicates a time to display a product on the broadcast video data channel.

16. The non-transitory computer-readable medium of claim 15, wherein the operations further comprise:
analyzing sentiment data associated with the product provider or associated with the product of the product provider;
analyzing one or more macro-economic factors associated with an economic environment to display the product on the broadcast video data channel; and
determining the one or more market conditions based on the sentiment data and the one or more macro-economic factors.

17. The non-transitory computer-readable medium of claim 15, wherein the operations further comprise:
applying a weight to an event associated with displaying the product on the broadcast video data channel; and
determining the at least one optimal time value for the product provider to display the product on the broadcast video data channel based on the weight of the event.

18. The non-transitory computer-readable medium of claim 15, wherein the operations further comprise:
generating the market condition data model to represent a result of marketing content on revenue for the product provider, wherein the market condition data model includes a machine learning algorithm, an adjusted regression algorithm, and a distribution plan to present the marketing content.

19. The non-transitory computer-readable medium of claim 15, wherein the operations further comprise:
determining one or more objectives of the product provider; and
selecting two or more channels on which to display the product based on the one or more objectives.

20. The non-transitory computer-readable medium of claim 15, wherein the operations further comprise:
generating spend guidelines for a marketing budget of the product provider, wherein the spend guidelines include a minimum spend amount the product provider should spend displaying the product on the broadcast video data channel and a maximum spend amount the product provider should spend displaying the product on the broadcast video data channel,
wherein the spend guidelines are generated by at least one machine-learning algorithm, wherein the at least one machine-learning algorithm is trained based on at least one dataset associated with previously generated spend guidelines.
